(19) United States
(12) Patent Application Publication
(10) Pub. No.: US 2020/0326905 A1
(43) Pub. Date: Oct. 15, 2020

(54) COMPUTER IMPLEMENTED METHOD AND COMPUTER SYSTEM FOR CUSTOMIZED EXECUTION OF A MEDIA FILE

(71) Applicant: Eduardo SANGUINO ORTIZ, Mexico City (MX)

(72) Inventor: Eduardo SANGUINO ORTIZ, Mexico City (MX)

(21) Appl. No.: 16/644,678

(22) PCT Filed: Aug. 31, 2018
(86) PCT No.: PCT/IB2018/056659

§ 371 Date: Mar. 5, 2020

Related U.S. Application Data
(60) Provisional application No. 62/555,506, filed on Sep. 7, 2017.
(60) Provisional application No. 62/634,382, filed on Feb. 23, 2018.

(51) Int. Cl. G06F 3/16; G06F 16/438; G06F 16/48

(52) U.S. Cl. CPC G06F 3/165; G06F 16/489; G06F 16/4387

(57) ABSTRACT

A computer implemented method for customized execution of a media file, the computer implemented method comprising steps of receiving a media file from a storage device, the media file having data corresponding to a plurality of instances of time, assigning a predetermined period of time to the media file, as a play time, assigning an instance of time and/or data, of the plurality of instances of time, as a starting instance of time and executing the media file calculated from the starting instance of time, for the play time.

### TECHNICAL FIELD

The present disclosure generally relates to execution of media files and in particular embodiments to a computer implemented method and a computer system for customized execution of media files, and generation of media playlists.

### BACKGROUND

A user generally stores a large number of media (audio and video) files in his/her library in a computing device, or can download the same in streaming services, but may not be equally interested in each one of them at all times. Some of the media files may be of special liking to the user, while others, the user may only wish to hear or view at certain specific times, such as during parties or while reading or while educating/entertaining himself herself. However, if the user wishes to enlist all of the media files in a playlist of a media player, the media player will go on playing all of the enlisted media files entirely, until the playlist is exhausted. This may not be of particular interest to the user, as the user may be interested in only specific portions of the enlisted media files. Some of the solutions in this regards are listed below:

U.S. Pat. No. 9,613,605B2 discloses a method, device and a system for identifying identical portions of a song, automatically splicing the song and shortening the song while retaining beginning, middle and ending of the song. In that manner, in one of the embodiments, two points of waveform similarity are identified and portions of the song between the two points are removed to shorten a length of the song. This way a listener will not be able to identify a splicing of the song.

WO2007105180A2 discloses a method, a medium and a computer program for automatic playlist generation. The method enables for definition of certain attribute variables and definition of patterns along which the attributes variable may vary. The attributes variables may be for example different genre or mood or tempo of songs. The playlist of the selected media content based on the defined patterns of variation of the selected attribute variables may then be created. Moreover, specific portions of the media content may be removed in order to meet the defined patterns.

These and other solutions, such as U.S. Pat. No. 9,070,351B2 may aim to provide computer implemented method and computer systems for customized execution of a media file; however, they suffer from a number of deficiencies. Most of the solutions present in the art do not allow a user to specify a length and a location at which, the user wants to listen or watch the media file from. Further, customization options are rather limited on very few parameters such as moods, genres and tempo etc. Also, there is no provision by which the user can rate or rank the media file, as per his/her liking, such that when the media file is encountered in the playlist, the media file is played according to ranking or rating provided by the user.

In light of the discussion above, there is need for a computer implemented method and a computer system for customized execution of a media file which alleviates one or more of the above mentioned deficiencies.

Any discussion of the background art throughout the specification should in no way be considered as an admission that such background art is prior art nor that such background art is widely known or forms part of the common general knowledge.

### SUMMARY

According to a first aspect of the present invention, there is provided a computer implemented method for customized execution of a media file, the computer implemented method comprising steps of receiving a media file from a storage device, the media file having data corresponding to a plurality of instances of time and/or data, assigning a predetermined period of time to the media file, as a play time, assigning an instance of time, of the plurality of instances of time, as a starting instance of time and executing the media file calculated from the starting instance of time, for the play time.

In one embodiment, the starting instance of time is the initial instance of time of the media file.

In one embodiment, the starting instance of time is an instance of time at the middle of the media file.

In one embodiment, the starting instance of time the final instance of time of the media file.

In one embodiment, the computer implemented method further comprises a step of receiving a value of the play time from an input device.

In one embodiment, the play time is selected from a group consisting of 1 minute, 2 minutes and 3 minutes.

In one embodiment, the starting instance of time is selected randomly from the plurality of instances of time.

In one embodiment, the play time is determined from indicia assigned to the media file.

In one embodiment, the play time is a percentage of the total duration of the media file, the percentage being proportional to the indicia assigned to the media file.

In one embodiment, the play time is a multiple of the indicia assigned to the media file.

In one embodiment, the play time is correlated to a plurality of parameters.

According to a second aspect of the present invention, there is provided a computer system for customized execution of a media file, the computer system comprising a memory unit configured to store machine readable instructions, a processor operably connected with the memory device, the processor obtaining the machine-readable instructions from the memory device, and being configured by the machine-readable instructions to receive a media file from a storage device, the media file having data corresponding to a plurality of instances of time and/or data, assign a predetermined period of time to the media file, as a play time, assign an instance of time, of the plurality of instances of time, as a stalling instance of time and execute the media file calculated from the starting instance of time, for the play time.

In one embodiment, the starting instance of time is the initial instance of time of the media file.

In one embodiment, the starting instance of time is an instance of time at the middle of the media file.

In one embodiment, the starting instance of time is the final instance of time of the media file.

In one embodiment, the processor is further configured to receive a value of the play time from an input device.

In one embodiment, the play time is selected from a group consisting of 1 minute, 2 minutes and 3 minutes.

In one embodiment, the starting instance of time is selected randomly from the plurality of instances of time.

In one embodiment, the processor is further configured to detemiine the play time from indicia assigned to the media file.

In one embodiment, the play time is a percentage of the total duration of the media file, the percentage being proportional to the indicia assigned to the media file.

In one embodiment, the play time is a multiple of the indicia assigned to the media file.

In one embodiment, the play time is correlated to a plurality of parameters.

### BRIEF DESCRIPTION OF THE DRAWINGS

Embodiments will be described with reference to the accompanying drawings, in which:

FIG. 1 illustrates an exemplary environment of computing devices to which various embodiments of the present invention may be implemented;

FIG. 2 illustrates a computer implemented method for customized execution of a media file, in accordance with an embodiment of the present invention; and

FIG. 3 illustrates execution of a media file calculated from different starting instances of time, in accordance with an embodiment of the present invention;

FIG. 4 illustrates a plurality of functional modules for enabling a processor for customized execution of a media file, in accordance with an embodiment of the present invention.

FIG. 5 illustrates a computer implemented method for customized execution of media file, in accordance with another embodiment of the present invention.

It should be noted that the same numeral represents the same or similar elements throughout the drawings.

### DETAILED DESCRIPTION

Throughout this specification, unless the context requires otherwise, the words “comprise”, “comprises” and “comprising” will be understood to imply the inclusion of a stated step or element or group of steps or elements but not the exclusion of any other step or element or group of steps or elements.

Any one of the terms: “including” or “which includes” or “that includes” as used herein is also an open term that also means including at least the elements/features that follow the term, but not excluding others.

Media files may typically contain audio or video content for a number of purposes such as entertainment, dissemination of information, education or the like. Media files may be stored by a user in their personal devices such as cellular phones, personal computer, tablets, PDAs or the like. Alternately, the media files may be streamed by the user, through a network, such as the Internet, using various available media provider services. Popular audio media file formats include MP3, WAV, AAC, WMA, OGG and M4A etc. Popular video media file formats include AVI, WMV, FLASH and H.264 etc.

We are considering here a scenario where, the user may want to hear or view only certain duration of a media file in a playlist. This may depend upon a number of factors such as popularity of the media file, mood of the user, or user's personal liking or other situations such as while creating party mixes. Further, the user may want to hear or view the media file from a certain location or point in the media file, such as from beginning, middle or end of the media file. In that view, computer implemented methods and computer systems have been disclosed below which allow the user to execute a particular media file for a predetermined period of time, i.e. a play time, calculated from a stalling instance of time. Further, the user is also allowed to assign indicia to the media file and set other parameters and the play time is determined as a function of the indicia assigned and other parameters set by the user,

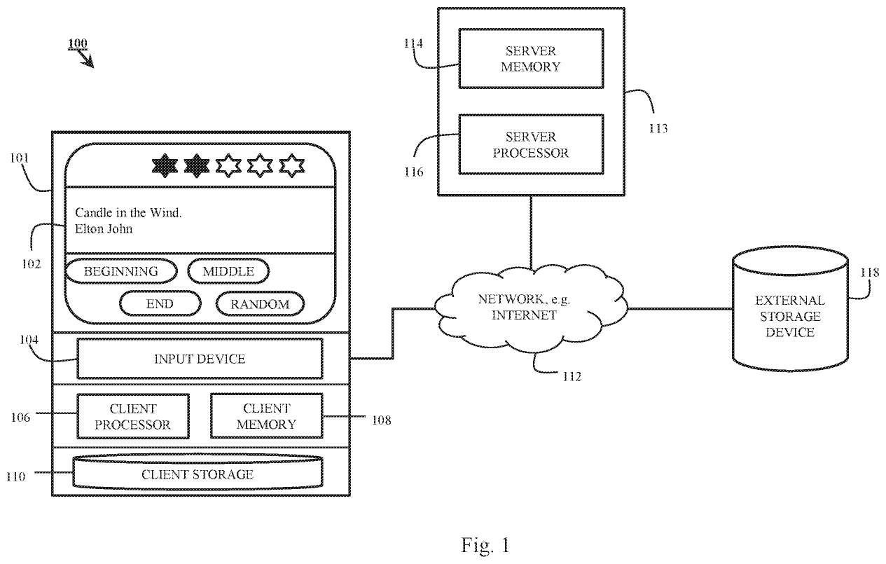

FIG. 1 illustrates an exemplary environment 100 of computing devices to which various embodiments of the present invention may he implemented. The environment 100 comprises a client device 101 associated with the user. In various embodiments of the invention, the client device 101 is selected from a group of a mobile handheld device, a PDA, a personal computer or a tablet etc. The client device 101 comprises a display device 102. The display device 102 may be one of, but not limited to, an LCD screen or an LED screen. Additionally, the client device 101 includes an input device 104. In various embodiments, the input device 104 is one of, but not limited to, a keypad, a joystick, a mouse and a trackball etc. In various other embodiments, the display device 102 and the input device 104 have been integrated into a capacitive or a resistive or an equivalent touch based screen device.

The client device 101 is envisaged to have further computing capabilities, such as, a client processor 106 and a client memory 108. In various embodiments, the client processor 106 is one of, but not limited to, Field Programmable Gate Array (FPGA), Application Specific Integrated Circuit (ASIC), general purpose or an ARM based processor. Additionally, the client memory 108 is one of, but not limited to, EPROM, EEPROM and Flash memory etc. The client device 101 is envisaged to have additional storage capabilities in form of additional client storage 110. The client storage 110 is envisaged to store media files in the client device 101, for the user's access.

The client device 101 is connected to a network 112. The network 112 is one of, but not limited to, a Local Area Network (LAN) or a Wide Area Network (WAN) implemented through a number of protocols, such as but not limited to, 802.x, Bluetooth, Zigbee or the like. Preferably, the network 112 is the Internet. Further connected to the network 112 is a media streaming server 113 associated with a media streaming service. The media streaming server 113 is envisaged to have computing capabilities such as a server memory 114 and a server processor 116. In various embodiments, the server processor 116 is one of, but not limited to, Field Programmable Gate Array (FPGA), Application Specific Integrated Circuit (ASIC), general purpose or an ARM based processor. Additionally, the server memory 114 is one of, but not limited to, EPROM, EEPROM and Flash memory etc. Media files associated with the media streaming service are envisaged to be stored in an external storage device 118 connected with the network 112. The external storage device may be a local storage device or a cloud based storage device. When the media files are requested by the user, at the client device 101, through the media streaming service, the media streaming server 113 fetches the media files from the external storage device 118 and delivers the media files to the client device 101 through the network 112.

Embodiments of the present invention can now be understood with the exemplary environment 100 as a reference. The method steps as will be described below are capable of being performed by either of the client processor 106 and the server processor 116. in case the media files are being accessed locally from the client storage 110, the method steps would be performed by the client processor 106. In case of the media files being streamed from the external storage device 118, through the network 112, the method steps would be performed by the server processor 116. Hence, meaning of the term ‘processor’ and ‘storage device’ in the following discussion will change accordingly on case to case basis.

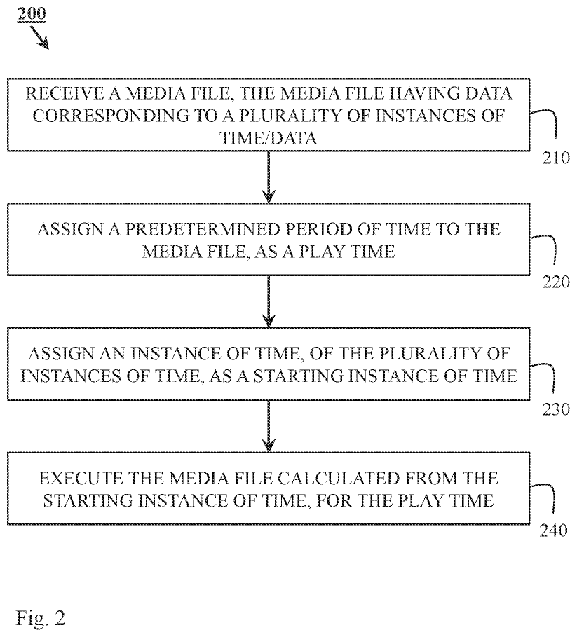

FIG. 2 illustrates a computer implemented method 200 for customized execution of a media file, in accordance with an embodiment of the present invention. The method 200 begins at step 210 when the processor (client processor 106 in case of local playing and server processor 116 in case of online streaming) receives a media file from a storage device (client storage 110 in case of local playing and external storage device 118 in case of online streaming). The media file is envisaged to have data corresponding to a plurality of instances of time and/or data. For example, a CD quality audio file has 44,100 frames/sec or in other words the audio file has a frame corresponding to every 1/44,100 of a second. Each of those frames has a 16-bit resolution or 16 bits of data for a particular instance of time. Such data when executed for consecutive instances of time creates an audio output. Similar kind of discussion can be presented for other audio and video formats. Moreover, the instances of data can queue an equivalent measure based on another computer parameter of the media file, for example the size.

The user may thus want to play the media file for a predetermined period of time only. In other words, the media file may be desired to be played for a predetermined number of instances of time only. Therefore, at step 220, the processor assigns a predetermined period of time to the media file, as a play time. The play time may be determined in a number of manners and ways and may depend upon a number of inputs, as will be discussed in the following discussion. In one embodiment, a value of the play time is received from the input device 104. This may be applicable to both local playing and online streaming. For example, the user may use a keypad to enter the play time as 120 s or 180 s or some random value such 152 s. In another embodiment, the play time is selected from a group consisting of 1 minute, 2 minutes and 3 minutes. Such options may be displayed at the display device 102 and the user may just have to click at one of the three options using a touch screen.

In another embodiment, the processor determines the play time from indicia assigned to the media file. Here, the indicia may be a rating or ranking such as 1-5 stars out of 5. Or 1-10 points out of 10. The option of providing indicia may be displayed at the display device 102 and the indicia may be received through the input device 104. Here, again, the indicia option may be available for both local playing and online streaming. For example, the play time for all non 5 star rated media files would be 2 minutes and play time for all 5 star rated media files would be 3 minutes. In another example, the play time for all 1 star rated media files is determined to be nil and media files are directly skipped without being played.

In one embodiment of the invention, the play time is a percentage of a total duration of the media file, the percentage being proportional to the indicia assigned to the media file. For example, for 1 star out of 5, the play time would be 20% of the total duration of the media file In another example, for 1 point out of 10, the play time would be 10% of the total duration of the media file. In another embodiment of the invention, the play time is a multiple of the indicia assigned to the media file. For example, for 1 star out of 5, the play time is 60×1=60 seconds. Similarly, for 3 stars out of 5, the play time is 60×3=180 seconds.

In yet another embodiment, the play time is correlated to a plurality of parameters. The pluralities of parameters include, but are not limited to, a mood of the user (such as reading, running, sad, leisure etc.), a situation, a requirement (such as party, running, education, entertainment etc.), or a time of a day (morning, afternoon, evening, late night etc.). For example, while creating a party mix, the processor may set the play time of all the media files in a playlist to 120 seconds. Whereas during leisure activities the processor may play 180 seconds of the media file. The plurality of parameters may be displayed to the user at the display device 102 and selection of the plurality of parameters may be received by the processor through the input device 104.

At step 230, the processor assigns an instance of time, of the plurality of instances of time, as a starting instance of time. In one embodiment of the invention, by default, the starting instance of tune is the initial instance of time of the media file, that is the beginning of a song or video. In various other embodiments, based on selections received from the user, through the input device 104, the starting instance of time is an instance of time at the middle of the media file; or is the final instance of time of the media file, that is the end of a song or video. Alternatively, the starting instance of time could be selected randomly from the plurality of instances of time,

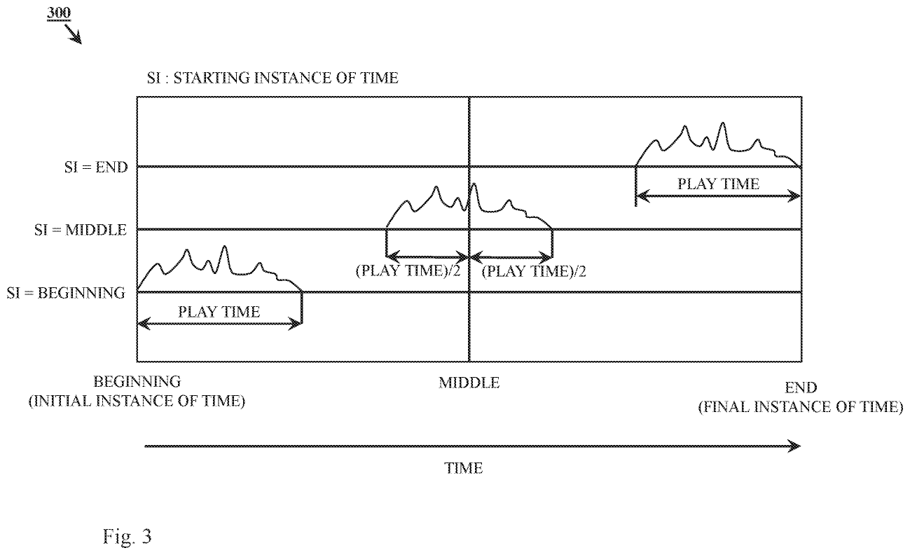

At step 240, the processor executes the media file calculated from the starting instance of time, for the play time. FIG. 3 illustrates execution of the media file calculated from different starting instances of time, in accordance with an embodiment 300 of the present invention. For example, in case of the starting instance of time being the initial instance of time, the media file is played from its beginning for the duration of the play time. For the starting instance of time at the middle of the media file, the play time is divided into two equal halves and the media file is executed from a point half the play time earlier than the middle of the media file. Similarly, if the starting point is the final instance (end) of the media file, the media file is executed from a point obtained by subtracting the play time from the value of the final instance. However, in case of random selection of the starting instance, the play time and the final instance of the media file limit up to what point, the random starting point can be delayed. For example, for a media file of total length of 4 minutes 32 seconds and play time 2 minutes (120 seconds), the random starting point cannot he later that 2 minutes and 32 seconds. Again various options for starting instances of time may be displayed on the display device 102 and selection of the starting instance of time may be received by the processor through the input device 104.

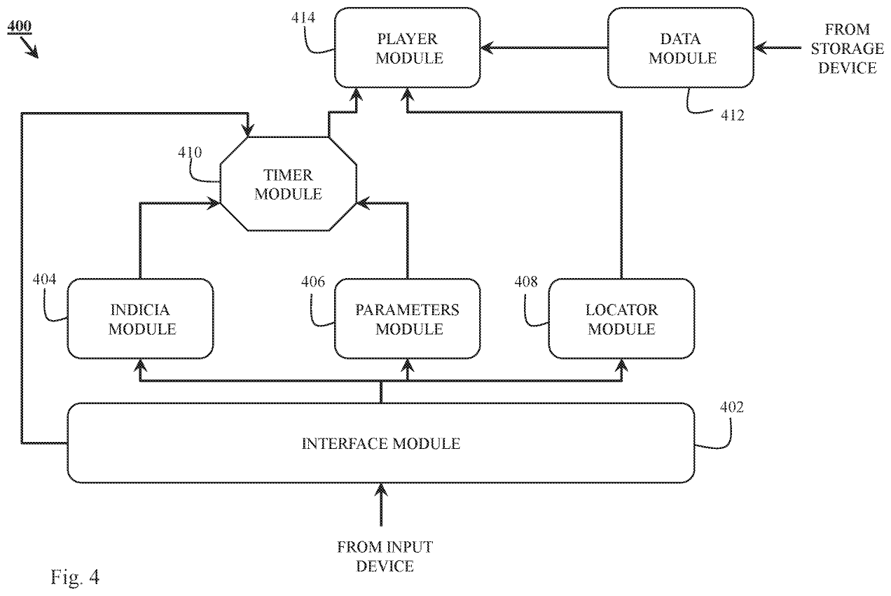

FIG. 4 illustrates a plurality of functional modules for enabling the processor (client processor 106 or the server processor 116, as the case may be) for customized execution of the media file, in accordance with an embodiment 400 of the present invention. These modules may be implemented in form of machine readable instructions, software, firmware, hardware and combinations thereof, in order to enable the processor to perform the method steps as discussed above. An interface module 402 enables the processor to receive selections of the indicia, the plurality of parameters and the stalling instances from the input device 104. An indicia module 404 enables the processor to manage the indicia. Similarly, a parameters module 406 enables the processor to manage the plurality of parameters. A locator module 408 enables the processor to manage the starting instance of time.

The interface module 402 may also enable the processor to receive the value of the play time from the input device 104 and feed it directly to a timer module 410. The timer module 410 may also enable the processor to receive inputs from the indicia module 404 and the parameters module 406 for determination of the play time. The play time is fed by the timer module 410 to a player module 414. Also, the starting instance of time is fed by the locator module 408 to the player module 414. The media file is fed to the player module 414, from the storage device, by a data module 412. The player module 414 then utilizes all of the inputs and enables the processor for executing the media files calculated from the starting instance of time, for the play time.

As discussed above, a user can play a list of media files, such as audio (song) or video files, establishing a general play time, i.e., a predetermined period of time and a starting instance of time, for example, at the beginning, the middle, or the end of the media files. Also, the user can assign an indicia such as likeliness or other parameters so that a percentage of a total duration of the media files can be played.

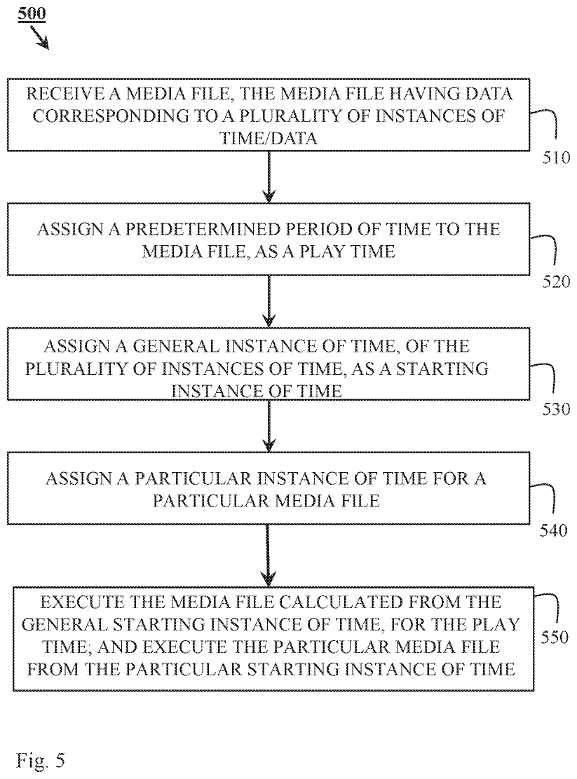

With reference to FIG. 5, in another embodiment of the present invention, in addition to the indicia or other parameters disclosed above, for each media file, the user can determine or establish a part of the media file that the user prefers, such as the beginning, the middle, or the end of the media file. In another embodiment of the present invention, the user can establish a starting instance of time for the whole list (general) of the media files and for each media file (particular). If a particular starting instance of time is disabled, the general starting instance of time will be applied. If a particular starting instance of time is available, then the particular starting instance of time will be selected.

Specifically, when setting or turning on the particular starting instance of time for a particular song, the user selects one of the beginning, the middle, or the end, and checks either “yes” or “no”. Then, automatically, the other two options that are not selected will be disabled. That is, only one of the beginning, the middle or the end for the particular starting instance of time can be selected.

For example, a user has an audio Album A that includes 5 songs, Tracks 1-5. The user can determine a general play time as 1 minute and a stalling instance of time as the middle (symmetrically from the middle). Then, all five songs, Tracks 1-5 in the album A will be played for one minute, from 30 seconds before the middle to 30 seconds after the middle of each song.

In the embodiment of the present invention, in addition to the general starting instance of time, the user can select a particular song, Track 2 to activate the particular starting instance of time. The user can turn on the option of a particular starting instance of time for Track 2 and check “yes” for the beginning of Track 2. The user does not determine a particular starting instance of time. The general starting instance of time applies to the rest of songs. Tracks I and 3-5. When the album A is played, Track 1 will he played for one minute from 30 seconds before the middle of Track 1 to 30 seconds after the middle of Track 1. Then, Track 2 will be played for one minute from the beginning of Track 2. Thereafter, Tracks 3-5 will be played for one minute from 30 seconds before the middle of each track to 30 seconds after the middle of each track.

In another embodiment of the present invention, the user can also select another particular song, Track 4 to activate the particular starting instance of time. The user can turn on the particular starting instance of time for Track 4 and check “no” for the middle of Track 4. The general setting remains the same, the general play time as 1 minute and the starting instance of time as middle. When the album A is played, Track 4 will not be played and skipped.

Furthermore, in another embodiment of the present invention, the user may enter commands and variables via voice commands. This voice control feature allows the user to perform all functions, such as selecting a song, establishing starting instance of time, turning on and off the option of particular starting instance of time, using voice commands and without having to use a keyboard or a touch screen.

The invention described above offers a number of advantages. First, the user does not need to listen or view entire lengths of media files against his/her wish. The invention enables for customized execution of the media files as per the duration and starting instance wished by the user. The user may even skip certain media files. The invention also enables users to rate and rank the media files, and the media files are played according ratings and rankings provided by the users. Additionally, the invention is suited for both local playing of media files on user's device and online streaming of media files. The play time of media files may be altered based on a multitude of factors such as ratings, moods and combinations thereof.

It should be understood that the techniques of the present disclosure might he implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data steams along a local network or a publically accessible network such as the Internet.

It should also be understood that, unless specifically stated otherwise as apparent from the following discussion, it is appreciated that throughout the description, discussions utilizing terms such as “controlling” or “obtaining” or “computing” or “storing” or “receiving” or “determining” or the like, refer to the action and processes of a computer system, or similar electronic computing device, that processes and transforms data represented as physical (electronic) quantities within the computer system's registers and memories into other data. similarly represented as physical quantities within the computer-system memories or registers or other such information storage, transmission or display devices.

It should be noted that where the terms “server”, “secure server” or similar terms are used herein, a communication device is described that may be used in a communication system, unless the context otherwise requires, and should not be construed to limit the present disclosure to any particular communication device type. Thus, a communication device may include, without limitation, a bridge, router, bridge-router (router), switch, node, or other communication device, which may or may not be secure.

It should also be noted that where a flowchart is used herein to demonstrate various aspects of the disclosure, it should not be construed to limit the present disclosure to any particular logic flow or logic implementation. The described logic may be partitioned into different logic blocks (e.g., programs, modules, functions, or subroutines) without changing the overall results or otherwise departing from the true scope of the disclosure. Often, logic elements may be added, modified, omitted, performed in a different order, or implemented using different logic constructs (e.g., logic gates, looping primitives, conditional logic, and other logic constructs) without changing the overall results or otherwise departing from the true scope of the disclosure.

The terms and descriptions used herein are set forth by way of illustration only and are not meant as limitations. Examples and limitations disclosed herein are intended to be not limiting in any manner, and modifications may he made without departing from the spirit of the present disclosure. Those skilled in the art will recognize that many variations are possible within the spirit and scope of the disclosure, and their equivalents, in which all terms are to be understood in their broadest possible sense unless otherwise indicated.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the disclosure is anticipated to hold on to all other such alternatives, modifications, and variations that fall within the scope of the present disclosure and appended claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. A computer implemented method for customized execution of media files, the computer implemented method comprising:
receiving a media file, the media file having data corresponding to a plurality of instances of time and/or data;
assigning a predetermined period of time to the media file, as a play time; wherein the play time is correlated to a plurality of parameters; and the play time is selected from a group consisting of 1 minute, 2 minutes, and 3 minutes, or any given defined time;
assigning an instance of time, of the plurality of instances of time, as a starting instance of time; and
executing the media file calculated from the starting instance of time, wherein every media file is played for the play time as defined, and every media file is played from the starting instance of time as selected.

25. The computer implemented method as claimed in claim 24, wherein the starting instance of time is: the initial instance of time of the media file, an instance of time at the middle of the media file, the final instance of time of the media file, or selected randomly from the plurality of instances of time.

26. The computer implemented method as claimed in claim 24, wherein the play time is determined from indicia assigned to the media file.

27. The computer implemented method as claimed in claim 24, wherein the plurality of parameters includes a mood of the user, a situation, a requirement, or a time of a day.

28. The computer implemented method as claimed in claim 24, further comprising setting or turning on the particular starting instance of time for a particular media file, in spite of the selected starting instance of time.

29. A computer implemented method for customized execution of media files, the computer implemented method comprising:
receiving a media file, the media file having data corresponding to a plurality—of instances of time and/or data;
assigning a predetermined period of time to the media file, as a play time; wherein the play time is correlated to a plurality of parameters; and the play time is determined from indicia assigned to each media file;
assigning an instance of time, of the plurality of instances of time, as a starting instance of time; and
executing the media file calculated from the starting instance of time, wherein every media file is played for the play time as defined.

30. The computer implemented method as claimed in claim 29, wherein the starting instance of time is: the initial instance of time of the media file, an instance of time at the middle of the media file, the final instance of time of the media file, or selected randomly from the plurality of instances of time.

31. The computer implemented method as claimed in claim 29, wherein the plurality of parameters includes a mood of the user, a situation, a requirement, or a time of a day.

32. The computer implemented method as claimed in claim 29, further comprising setting or turning on the particular starting instance of time for a particular media file, in spite of the selected starting instance of time.

33. A computer system for customized execution of media files, the computer system, comprising;
memory configured to store machine readable instructions; and a processor operably connected with the memory, the processor obtaining the machine-readable instructions from the memory device, the processor being configured by the machine-readable instructions to:
receive a media file, the media file having data corresponding to a plurality of instances of time and/or data;
assign a predetermined period of time to the media file, as a play time; wherein the play time is correlated to a plurality of parameters; and the play time is selected from a group consisting of 1 minute, 2 minutes, and 3 minutes, or any given defined time;
assign an instance of time, of the plurality of instances of time, as a starting instance of time; and
execute the media file calculated from the starting instance of time, wherein every media file is played for the play time as defined, and every media file is played from the starting instance of time as selected.

34. The computer system as claimed in claim 33, wherein the starting instance of time is: the initial instance of time of the media file, an instance of time at the middle of the media file, the final instance of time of the media file, or selected randomly from the plurality of instances of time.

35. The computer system as claimed in claim 33, wherein the processor is further configured to determine the play time from indicia assigned to the media file.

36. The computer system as claimed in claim 33, wherein the plurality of parameters includes a mood of the user, a situation, a requirement, or a time of a day.

37. The computer system as claimed in claim 33, wherein the processor is further configured to set or tune on the particular starting instance of time for a particular media file.

38. A computer system for customized execution of media files, the computer system, comprising;
memory configured to store machine readable instructions;
and a processor operably connected with the memory, the processor obtaining the machine-readable instructions from the memory device, the processor being configured by the machine-readable instructions to:
receive a media file, the media file having data corresponding to a plurality—of instances of time and/or data;
assign a predetermined period of time to the media file, as a play time; wherein the play time is correlated to a plurality of parameters; and the play time is determined from indicia assigned to each media file;
assign an instance of time, of the plurality of instances of time, as a starting instance of time; and
execute the media file calculated from the starting instance of time, wherein every media file is played for the play time as defined.

39. The computer system as claimed in claim 38, wherein the starting instance of time is: the initial instance of time of the media file, an instance of time at the middle of the media file, the final instance of time of the media file, or selected randomly from the plurality of instances of time.

40. The computer system as claimed in claim 38, wherein the plurality of parameters includes a mood of the user, a situation, a requirement, or a time of a day.

41. The computer system as claimed in claim 38, wherein the processor is further configured to set or tune on the particular starting instance of time for a particular media file.

42. A non-transitory computer-readable medium including code for performing a process to be executed on a computer, the process comprising:
receiving a media file, the media file having data corresponding to a plurality of instances of time and/or data;
assigning a predetermined period of time to the media file, as a play time; wherein the play time is correlated to a plurality of parameters; and the play time is selected from a group consisting of 1 minute, 2 minutes, and 3 minutes, or any given defined time;
assigning an instance of time, of the plurality of instances of time, as a starting instance of time; and
executing the media file calculated from the starting instance of time, wherein every media file is played for the play time as defined, and every media file is played from the starting instance of time as selected.

43. A non-transitory computer-readable medium including code for performing a process to be executed on a computer, the process comprising:
receiving a media file, the media file having data corresponding to a plurality—of instances of time and/or data;
assigning a predetermined period of time to the media file, as a play time; wherein the play time is correlated to a plurality of parameters; and the play time is determined from indicia assigned to each media file;
assigning an instance of time, of the plurality of instances of time, as a starting instance of time; and
executing the media file calculated from the starting instance of time, wherein every media file is played for the play time as defined.
